(19) United States
(12) Patent Application Publication
(10) Pub. No.: US 2026/0295468 A1
(43) Pub. Date: Oct. 1, 2026

(54) LIQUID TRANSFER APPARATUS

(71) Applicant: EBARA CORPORATION, Tokyo (JP)

(72) Inventors: Tetsuji KASATANI, Tokyo (JP); Kei WATAJI, Tokyo (JP); Hyuga KIKUCHI, Tokyo (JP); Asaki SUZUKI, Tokyo (JP); Akihiro HARA, Tokyo (JP)

(21) Appl. No.: 19/490,097

(22) PCT Filed: Jun. 5, 2024
(86) PCT No.: PCT/JP2024/020458

§ 371 Date: Dec. 4, 2025

(30) Foreign Application Priority Data
Jun. 9, 2023 (JP) 2023-095374

(51) Int. Cl. B01D 19/00; F04D 7/00

(52) U.S. Cl. CPC B01D 19/0042; F04D 7/00

(57) ABSTRACT

The present application relates to a liquid transfer apparatus. The liquid transfer apparatus for transferring a liquefied gas includes a gas entrainment prevention device is configured to collect bubbles generated from the liquefied gas before the bubbles are sucked into a pump.

### TECHNICAL FIELD

The present invention relates to a liquid transfer apparatus.

### BACKGROUND ART

A pot-type pump connected to a pipe extending from a liquefied gas tank is known as a pump for transferring low-temperature liquefied gas. Such a pot-type pump is configured to transfer the liquefied gas in the liquefied gas tank when operated.

### CITATION LIST

### Patent Literature

Patent document 1: Japanese laid-open patent publication No. 2009-240986

Patent document 2: Japanese laid-open patent publication No. 2014-134142

Patent document 3: Japanese laid-open patent publication No. 2011-247575

Patent document 4: Japanese laid-open patent publication No. 2018-199116

### SUMMARY OF INVENTION

### Technical Problem

The liquefied gas has a very low boiling point. Therefore, some of the liquefied gas may vaporize due to external heat input or other factors. The vaporized gas (i.e., bubbles) is called boil-off gas (BOG). If a gas is generated upstream of the pump suction port in the flow direction of the liquefied gas, the gas may be sucked into the pump suction port along with the liquefied gas. The gas sucked into the pump suction port may cause a decrease in pump performance.

The liquefied gas has a very low boiling point. Therefore, some of the liquefied gas may vaporize due to external heat input or other factors. As in Patent document 2 (i.e., Japanese laid-open patent publication No. 2014-134142), if an additional component (e.g., a vortex prevention member) is provided that contacts the external room-temperature area to prevent the pump from drawing in air (gas), the external heat input to the liquid transfer apparatus increases, resulting in the generation of more vaporized gas. The generation of more gas increases the likelihood that the pump will draw in the gas, which may lead to a decrease in pump performance.

Therefore, an object of the present invention to provide a liquid transfer apparatus that prevents a gas from being sucked into a pump.

### Solution to Problem

In an embodiment, there is provided a liquid transfer apparatus comprising: a pump configured to suck a liquefied gas from below the pump and transfer the liquefied gas upward the pump; a vertical pipe in which the pump is disposed; a horizontal pipe configured to supply the liquefied gas to a position in the vertical pipe below the pump; and a gas entrainment prevention device configured to be supported by the pump and isolated from the vertical pipe, and to collect bubbles generated from the liquefied gas before the bubbles are sucked into the pump.

In an embodiment, the gas entrainment prevention device comprises a plate-shaped member extending downward along a side of the pump facing the side of the vertical pipe, and a tip portion of the plate-shaped member extends toward the horizontal pipe.

In an embodiment, the plate-shaped member is configured to form a bubble flow path through which the bubbles flow between the vertical pipe and the plate-shaped member.

In an embodiment, the plate-shaped member has a bent portion bent toward an upstream side of the horizontal pipe at an intermediate part of the plate-shaped member.

In an embodiment, the gas entrainment prevention device comprises a funnel-shaped member configured to be suspended from a suction port of the pump and collect the bubbles.

In an embodiment, the funnel-shaped member has a diameter larger than a diameter of the suction port.

In an embodiment, the gas entrainment prevention device comprises a gas discharge pipe connected to the funnel-shaped member.

In an embodiment, the gas entrainment prevention device comprises a guide member disposed in the horizontal pipe, and the guide member is configured to generate a swirling flow of the liquefied gas by constricting a flow of the liquefied gas flowing through the horizontal pipe.

### Advantageous Effects of Invention

During pump operation, some of the liquefied gas transported from the liquefied gas tank to a suction port of the pump may vaporize and form bubbles. A gas entrainment prevention device collects the bubbles generated from the liquefied gas in a vertical pipe before they are sucked into the pump, preventing the pump from sucking in the bubbles.

The gas entrainment prevention device is provided in the pump apparatus but is not connected to a vacuum double pipe. Therefore, the heat outside the inner tube of the vacuum double pipe, i.e., the external heat, is not transferred from the vacuum double pipe to the gas entrainment prevention device, and the gas generated from the liquefied gas can be separated, and the intake of bubbles by the pump can be prevented.

### BRIEF DESCRIPTION OF DRAWINGS

FIG. 1 is a view showing an embodiment of a liquid transfer apparatus;

FIG. 2 is a schematic view showing a pump apparatus;

FIG. 3A is a view showing a gas entrainment prevention device having a bent tip portion;

FIG. 3B is a view showing a gas entrainment prevention device having a tip portion extending parallel to a base portion;

FIG. 4A is a view showing an example of a gas entrainment prevention device when a vertical pipe is viewed from the direction in which the vertical pipe extends;

FIG. 4B is a view showing an example of a gas entrainment prevention device when a vertical pipe is viewed from the direction in which the vertical pipe extends;

FIG. 4C is a view showing an example of a gas entrainment prevention device when a vertical pipe is viewed from the direction in which the vertical pipe extends;

FIG. 5 is a view showing another embodiment of the gas entrainment prevention device; and

FIG. 6 is a view showing the gas entrainment prevention device shown in FIG. 5 when the vertical pipe is viewed from the direction in which the vertical pipe extends.

### DESCRIPTION OF EMBODIMENTS

Embodiments of the present invention will be described with reference to the accompanying drawings. In the following description, identical or corresponding components are designated by the same reference numerals, and redundant description thereof will be omitted.

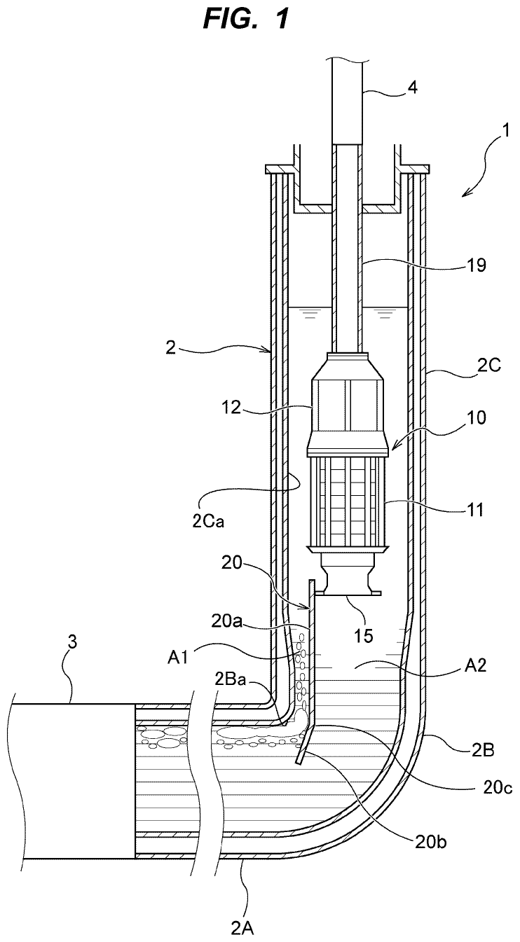

FIG. 1 is a view showing an embodiment of a liquid transfer apparatus. The liquid transfer apparatus 1 is configured to transfer a cryogenic liquefied gas (e.g., liquefied hydrogen). As shown in FIG. 1, the liquid transfer apparatus 1 includes a vacuum double pipe 2 and a pump apparatus 10 disposed within the vacuum double pipe 2.

The vacuum double pipe 2 has a horizontal pipe 2A extending horizontally, a vertical pipe 2C extending vertically, and an elbow pipe 2B connecting the horizontal pipe 2A and the vertical pipe 2C. Each of the horizontal pipe 2A, the elbow pipe 2B, and the vertical pipe 2C has an outer cylinder and an inner cylinder, and a vacuum is formed between the outer cylinder and the inner cylinder. The vacuum double pipe 2 having such a structure can suppress heat input to the liquefied gas flowing through the vacuum double pipe 2 and vaporization of the liquefied gas due to external heat input.

The pump apparatus 10 is disposed inside the vertical pipe 2C, and the horizontal pipe 2A and the elbow pipe 2B are disposed below the pump apparatus 10. The horizontal pipe 2A supplies the liquefied gas to a position in the vertical pipe 2C below the pump apparatus 10 (more specifically, the pump 11). In the embodiment shown in FIG. 1, a suction pipe 3 is connected to the horizontal pipe 2A. For example, the suction pipe 3 is connected to the liquefied gas tank (not shown). By operating the pump apparatus 10, the liquefied gas in the liquefied gas tank flows into the vacuum double pipe 2 through the suction pipe 3. The liquefied gas flowing through the horizontal pipe 2A and the elbow pipe 2B is sucked into the pump apparatus 10 disposed in the vertical pipe 2C.

As shown in FIG. 1, a discharge nozzle 19 is connected to the pump apparatus 10, and a discharge pipe 4 is connected to the discharge nozzle 19. Therefore, the liquefied gas sucked into the pump apparatus 10 is transferred to the outside through the discharge nozzle 19 and the discharge pipe 4.

In this manner, the liquid transfer apparatus 1 of the type that sucks in the liquefied gas flowing through the horizontal pipe 2A and the elbow pipe 2B arranged below the pump apparatus 10 may be called a bottom-suction pot-type pump. Unlike general pot-type pump systems (i.e., pump systems in which the suction pipe cannot be attached to a bottom of the suction pot), the bottom-suction pot-type pump can be fitted with a large-diameter suction pipe 3 and can transfer the liquefied gas at a large flow rate with low pressure loss.

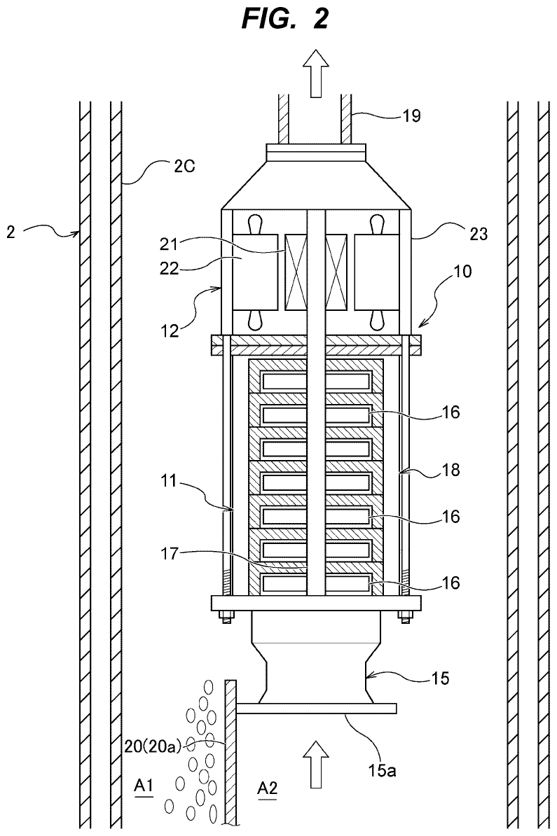

FIG. 2 is a schematic view showing the pump apparatus. As shown in FIG. 2, the pump apparatus 10 includes a pump 11 disposed inside the vertical pipe 2C and a motor 12 that drives the pump 11. For example, the pump apparatus 10 is a submerged motor pump.

The pump 11 includes a plurality of impellers 16 fixed to a rotating shaft 17, and a pump casing 18 that houses the plurality of impellers 16. In the embodiment shown in FIG. 2, the impellers 16 are arranged, but at least one impeller 16 may be arranged. The pump casing 18 has a suction bell mouth 15 arranged below the impellers 16 (more specifically, the first stage), and the suction bell mouth 15 has a suction port 15a that opens downward.

The motor 12 includes a rotor 21 fixed to the rotating shaft 17, a stator 22 surrounding the rotor 21, and a motor casing 23 accommodating the rotor 21 and the stator 22. The rotor 21 and the stator 22 constitute rotating elements.

When power is supplied to the motor 12, the rotating shaft 17 and the impellers 16 rotate together with the rotor 21, and the liquefied gas is introduced into the pump apparatus 10 through the suction port 15a of the suction bell mouth 15. The liquefied gas that has passed through the pump apparatus 10 is transported to the outside through the discharge nozzle 19 and the discharge pipe 4 (see FIG. 1).

When the liquefied gas flowing through the vacuum double pipe 2 evaporates, a gas (in other words, bubbles) is generated within the vacuum double pipe 2. In particular, when the gas is generated in the horizontal pipe 2A, there is a risk that the gas will be sucked into the pump 11 through the suction bell mouth 15. In this case, the suction of gas will cause a decrease in a performance of the pump 11. Therefore, the liquid transfer apparatus 1 includes a gas entrainment prevention device 20 that isolates the gas generated from the liquefied gas flowing through the horizontal pipe 2A (and the elbow pipe 2B) from the suction port 15a.

The gas entrainment prevention device 20 is supported by the pump 11, isolated from the vertical pipe 2C, and is configured to recover the gas generated from the liquefied gas within the vertical pipe 2C before the gas is sucked into the pump 11.

In the embodiment shown in FIGS. 1 and 2, the gas entrainment prevention device 20 comprises a plate-shaped member extending along the vertical pipe 2C downward from the suction port 15a. More specifically, the gas entrainment prevention device 20 as a plate-shaped member has a base portion 20a connected to the suction bell mouth 15 and extending parallel to the vertical pipe 2C, and a tip portion 20b extending downward from the base portion 20a. In this embodiment, the base portion 20a and the tip portion 20b are integrally molded members, but may also be formed from separate members.

The gas entrainment prevention device 20, which is a plate-shaped member, extends downward along an inner-side inner surface 2Ca of the vertical pipe 2C from a side of the pump 11 facing the inner-side inner surface 2Ca (i.e., the side surface of the vertical pipe). The tip portion 20b of the gas entrainment prevention device 20 extends toward the horizontal pipe 2A.

The gas entrainment prevention device 20 forms a gas flow path (in other words, a bubble flow path) A1 through which gas flows between the vertical pipe 2C and the gas entrainment prevention device 20 (a plate-shaped member in this embodiment). In other words, the gas entrainment prevention device 20 divides a space of the vertical pipe 2C into a space (gas flow path A1) through which gas generated from the liquefied gas flows, and a space (liquid flow path) A2 through which the liquefied gas flows.

According to this embodiment, the gas entrainment prevention device 20 can cause gas generated from the liquefied gas to flow into the gas flow path A1, while causing the liquefied gas to flow into the liquid flow path A2. The suction port 15a of the suction bell mouth 15 is located in the liquid flow path A2. Therefore, the liquefied gas flowing through the liquid flow path A2 is sucked into the suction port 15a, and the gas flowing through the gas flow path A1 rises up the vertical pipe 2C without being sucked into the suction port 15a. As a result, the gas entrainment prevention device 20 can prevent gas from being sucked into the pump 11.

The gas generated from the liquefied gas flowing through the horizontal pipe 2A (or the suction pipe 3) is collected at a top of the horizontal pipe 2A due to its buoyancy. The gas collected at the top of the horizontal pipe 2A flows along the inner curved surface 2Ba of the elbow pipe 2B and the inner-side inner surface 2Ca of the vertical pipe 2C, separated from the liquefied gas (see FIG. 1).

The horizontal pipe 2A has a length that allows the gas (i.e., bubbles) generated from the liquefied gas to be collected at the top of the horizontal pipe 2A. A length of the horizontal pipe 2A is determined based on factors such as the type of liquefied gas to be transferred and the flow rate of the liquefied gas. By ensuring a sufficient length of the horizontal pipe 2A, the gas can be reliably separated from the liquefied gas, and the gas entrainment prevention device 20 disposed on the inner-side inner surface 2Ca of the vertical pipe 2C can more effectively isolate the gas from the liquefied gas.

An inner curved surface 2Ba of the elbow pipe 2B is the portion with the smallest radius of curvature among the bent portions of the elbow pipe 2B. The inner-side inner surface 2Ca of the vertical pipe 2C is the portion connected to the inner curved surface 2Ba. The gas entrainment prevention device 20 is disposed opposite the inner-side inner surface 2Ca. Therefore, the gas flow path A1 is formed between the inner-side inner surface 2Ca of the vertical pipe 2C and the gas entrainment prevention device 20. With this configuration, the gas flowing along the inner curved surface 2Ba and the inner-side inner surface 2Ca is reliably introduced into the gas flow path A1.

In order to more effectively isolate the gas from the liquefied gas, it is preferable that an upper part of the tip portion 20b extend to below the vertical pipe 2C. More preferably, the upper part of the tip portion 20b extends to an intermediate position of the horizontal pipe 2A. More specifically, when the horizontal pipe 2A is viewed from a direction in which the horizontal pipe 2A extends, the upper part of the tip portion 20b extends to a center of the horizontal pipe 2A. In other words, the upper part of the tip portion 20b does not reach a bottom of the vacuum double pipe 2. With this configuration, the gas entrainment prevention device 20 can cause the gas to flow into the gas flow path A1 while suppressing pressure loss and causing the liquefied gas to flow into the liquid flow path A2.

The gas entrainment prevention device 20 is connected to the pump apparatus 10 (pump 11 in this embodiment), but is not connected to the vacuum double pipe 2. When the gas entrainment prevention device 20 is connected to the vacuum double pipe 2 (for example, the upper part of the horizontal pipe 2A), the gas entrainment prevention device 20 captures gas generated on the upstream side of the horizontal pipe 2A. However, in this case, there is a possibility that heat outside the inner cylinder of the vacuum double pipe 2, i.e., external heat, may be transmitted to the gas entrainment prevention device 20 through the vacuum double pipe 2.

When external heat is transferred to the gas entrainment prevention device 20, the temperature of the gas entrainment prevention device 20 rises, and as a result, gas may be generated around the gas entrainment prevention device 20. If gas is generated downstream of the gas entrainment prevention device 20, the gas entrainment prevention device 20 will not be able to capture the gas, and as a result, the gas may flow into the suction port 15a of the suction bell mouth 15.

According to this embodiment, by connecting the gas entrainment prevention device 20 to the pump apparatus 10, it is possible to prevent gas from being generated around the gas entrainment prevention device 20, and as a result, gas is prevented from being generated downstream of the gas entrainment prevention device 20. Therefore, the above-described problems do not occur.

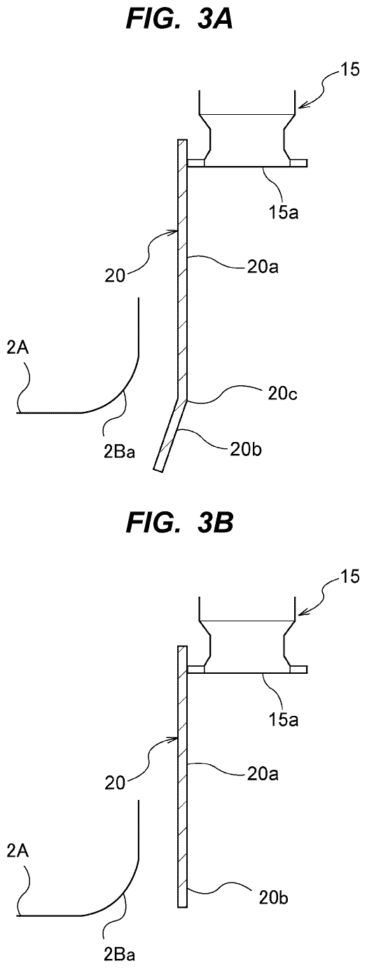

FIG. 3A is a view showing a gas entrainment prevention device having a bent tip portion, and FIG. 3B is a view showing a gas entrainment prevention device having a tip portion extending parallel to the base portion. As shown in FIG. 3A, the gas entrainment prevention device 20 has a bent portion 20c that is bent toward an upstream side (i.e., on the suction pipe 3 side) of the horizontal pipe 2A at an intermediate part thereof.

The bent portion 20c is disposed between the base portion 20a and the tip portion 20b, and is bent obliquely downward toward the inner curved surface 2Ba (or the horizontal pipe 2A). With this shape, the tip portion 20b can reliably capture the gas flowing through the horizontal pipe 2A and the elbow pipe 2B, and can more reliably prevent the gas from passing through the gas entrainment prevention device 20 and flowing toward the liquid flow path A2.

In one embodiment, the gas entrainment prevention device 20 may not have the bent portion 20c, depending on the shape of the vacuum double pipe 2, the flow rate of the liquefied gas, and other conditions. As shown in FIG. 3B, the gas entrainment prevention device 20 may have the tip portion 20b extending parallel to the base portion 20a. In this case, the gas entrainment prevention device 20 as a whole extends parallel to the vertical pipe 2C.

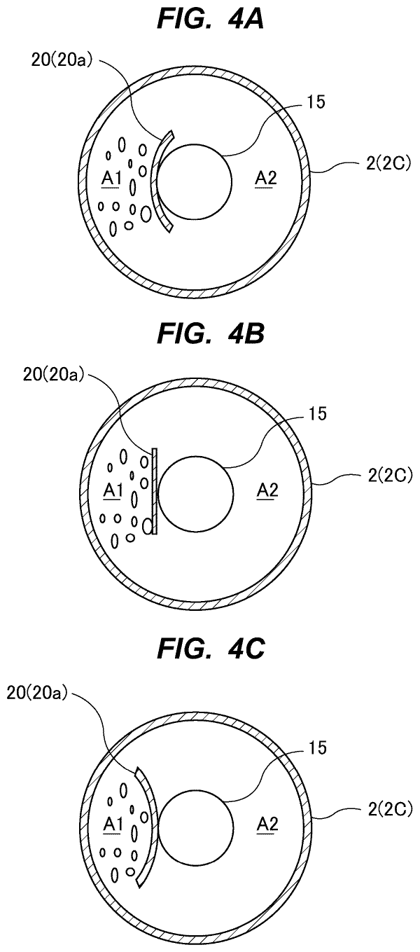

FIGS. 4A to 4C are views showing an example of a gas entrainment prevention device when a vertical pipe is viewed from the direction in which the vertical pipe extends. In the embodiment shown in FIGS. 4A and 4C, when the vertical pipe 2C is viewed from the direction in which the vertical pipe 2C extends, the gas entrainment prevention device 20 has the base portion 20a having a curved shape. In the embodiment shown in FIG. 4B, when the vertical pipe 2C is viewed from the direction in which the vertical pipe 2C extends, the gas entrainment prevention device 20 has the base portion 20a having a straight shape.

In the embodiment shown in FIG. 4A, the base portion 20a has an arc shape that follows the outer shape of the suction bell mouth 15. In the embodiment shown in FIG. 4C, the base portion 20a is curved in the opposite direction to the outer shape of the suction bell mouth 15.

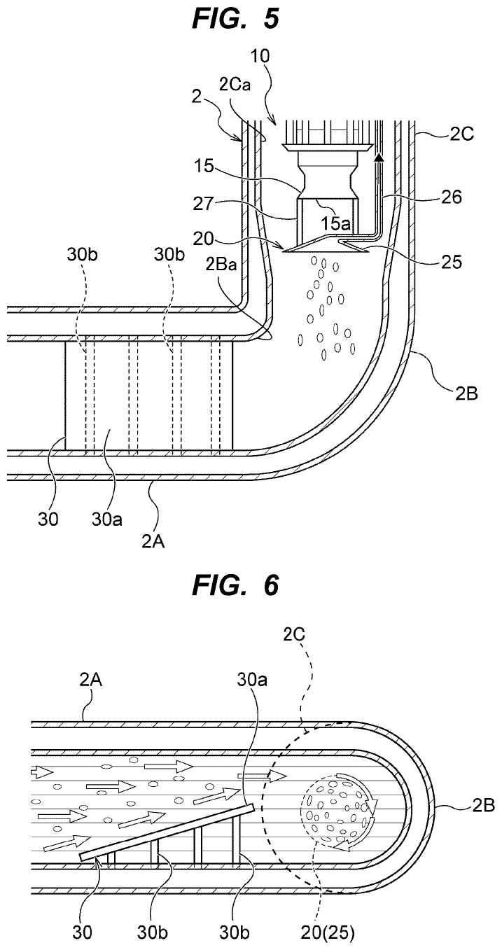

FIG. 5 is a view showing another embodiment of the gas entrainment prevention device. In the embodiment shown in FIG. 5, the gas entrainment prevention device 20 includes a funnel-shaped member 25 that collects gas generated from the liquefied gas, and a suspension member 27 that suspends the funnel-shaped member 25 from the suction port 15a of the suction bell mouth 15.

The funnel-shaped member 25 is disposed below the suction port 15a and has a structure that isolates the gas from the suction port 15a. The funnel-shaped member 25 has a diameter larger than the diameter of the suction port 15a. By disposing the funnel-shaped member 25 below the suction port 15a, the funnel-shaped member 25 captures (recovers) the gas rising up the vertical pipe 2C.

By trapping the gas in the funnel-shaped member 25, the liquefied gas not containing gas (gas bubbles) ascending through the vertical pipe 2C is sucked into the suction port 15a located above the funnel-shaped member 25. In the embodiment shown in FIG. 5, the funnel-shaped member 25 has a conical shape, but the shape of the funnel-shaped member 25 is not particularly limited as long as it can trap the gas.

As shown in FIG. 5, the gas entrapment prevention device 20 may include a gas discharge pipe 26 connected to the funnel-shaped member 25. The gas discharge pipe 26 extends parallel to the vertical pipe 2C and is configured to exhaust the gas collected in the funnel-shaped member 25 to the outside.

The gas entrainment prevention device 20 is connected to the pump apparatus 10 (in this embodiment, the suction bell mouth 15), but is not connected to the vacuum double pipe 2. When the gas entrainment prevention device 20 is connected to the vacuum double pipe 2 (for example, the inner-side inner surface 2Ca of the vertical pipe 2C), the gas entrainment prevention device 20 captures gas generated upstream of the horizontal pipe 2A. However, in this case, there is a possibility that heat outside the inner cylinder of the vacuum double pipe 2, i.e., external heat, will be transmitted to the gas entrainment prevention device 20 through the vacuum double pipe 2.

When external heat is transmitted to the gas entrainment prevention device 20, the temperature of the gas entrainment prevention device 20 rises, and as a result, gas may be generated around the gas entrainment prevention device 20. If gas is generated downstream of the gas entrainment prevention device 20, the gas entrainment prevention device 20 will not be able to capture the gas, and as a result, the gas may flow into the suction port 15a of the suction bell mouth 15.

FIG. 6 is a view showing the gas entrainment prevention device shown in FIG. 5 when the vertical pipe is viewed from the direction in which the vertical pipe extends. As shown in FIG. 6, the gas entrainment prevention device 20 may include a guide member 30 arranged in the horizontal pipe 2A. The guide member 30 is configured to generate a swirling flow in the vertical pipe 2C by throttling the flow of liquefied gas flowing through the horizontal pipe 2A. The guide member 30 is arranged as an auxiliary member, and allows gas generated from the liquefied gas to be more actively collected in the funnel-shaped member 25.

As shown in FIG. 6, the guide member 30 includes an inclined plate 30a disposed at an angle with respect to the extension direction of the horizontal pipe 2A, and a plurality of mounting members 30b for mounting the inclined plate 30a to the horizontal pipe 2A. The number of mounting members 30b is not limited to this embodiment. In the embodiment shown in FIG. 6, the inclined plate 30a is disposed on one side of the horizontal pipe 2A by the mounting members 30b, but it may also be disposed on the other side (opposite surface).

A flow velocity of the liquefied gas flowing through the horizontal pipe 2A is determined by dividing the flow rate of the liquefied gas by the cross-sectional area of the horizontal pipe 2A. Therefore, under the condition that the flow rate of the liquefied gas is constant, if the cross-sectional area of the horizontal pipe 2A is smaller, the flow velocity of the liquefied gas will be faster. The guide member 30 reduces the cross-sectional area of the horizontal pipe 2A (i.e., the flow path of the liquefied gas). Therefore, the guide member 30 increases the flow velocity of the liquefied gas flowing through the horizontal pipe 2A.

By arranging the guide member 30, the flow path of the liquefied gas is narrowed, causing the flow to become biased and accelerated as it flows through the elbow pipe 2B and the vertical pipe 2C. After passing through the horizontal pipe 2A and the guide member 30, the liquefied gas forms a swirling flow when passing through the elbow pipe 2B (see the arrows in FIG. 6). When a swirling flow of the liquefied gas is formed, centrifugal force due to the swirling flow acts on the liquefied gas and the gas (bubbles) generated from the liquefied gas.

The liquefied gas has a higher density than gas (bubbles). Therefore, low-density gas collects toward the center of the vertical pipe 2C, while high-density liquefied gas swirls outside the vertical pipe 2C (i.e., outside the gas that collects toward the center). The funnel-shaped member 25 is disposed toward the center of the vertical pipe 2C. Therefore, the gas that collects toward the center of the vertical pipe 2C is actively collected by the funnel-shaped member 25.

In this embodiment, the funnel-shaped member 25 is also connected to the pump apparatus 10 (more specifically, the suction bell mouth 15 of the pump 11) via the suspension member 27, thereby preventing gas from being generated downstream of the funnel-shaped member 25.

The embodiments shown in FIGS. 1 to 4 may be combined as appropriate with the embodiments shown in FIGS. 5 and 6. More specifically, the gas entrainment prevention device 20 may include the plate-shaped member shown in FIGS. 1 to 4 and the funnel-shaped member 25 shown in FIGS. 5 and 6. With this configuration, the gas entrainment prevention device 20 can more reliably prevent gas from being sucked into the pump 11.

The above-described embodiments have been described for the purpose of enabling a person of ordinary skill in the art to practice the present invention. Various modifications of the above-described embodiments would naturally be possible for a person skilled in the art, and the technical concept of the present invention may also be applied to other embodiments. Therefore, the present invention is not limited to the described embodiments, but is to be interpreted in the broadest scope in accordance with the technical concept defined by the claims.

### Industrial Applicability

The present invention is applicable to a liquid transfer apparatus.

### REFERENCE SIGNS LIST

1 liquid transfer apparatus
2 vacuum double pipe
2A horizontal pipe
2B elbow pipe
2Ba inner curved surface
2C vertical pipe
2Ca inner-side inner surface
3 suction pipe
4 discharge pipe
10 pump apparatus
11 pump
12 motor
15 suction bell mouth
15a suction port
16 impeller
17 rotating shaft
18 pump casing
19 discharge nozzle
20 gas entrainment prevention device
20a base portion
20b tip portion
20c bent portion
21 rotor
22 stator
23 motor casing
25 funnel-shaped member
26 gas discharge pipe
27 suspension member
30 guide member
30a inclined plate
306 mounting member

What is claimed is:

1. A liquid transfer apparatus comprising:
a pump configured to suck a liquefied gas and transfer the liquefied gas upward the pump;
a pipe in which the pump is disposed; and
a gas entrainment prevention device configured to be supported by the pump and not to be connected to the pipe, and to collect bubbles generated from the liquefied gas before the bubbles are sucked into the pump.

2. The liquid transfer apparatus according to claim 1, wherein the gas entrainment prevention device comprises a plate-shaped member extending downward along a side of the pump facing the side of a vertical pipe, and
wherein a tip portion of the plate-shaped member extends toward a horizontal pipe.

3. The liquid transfer apparatus according to claim 2, wherein the plate-shaped member is configured to form a bubble flow path through which the bubbles flow between the vertical pipe and the plate-shaped member.

4. The liquid transfer apparatus according to claim 2, wherein the plate-shaped member has a bent portion bent toward an upstream side of the horizontal pipe at an intermediate part of the plate-shaped member.

5. The liquid transfer apparatus according to claim 1, wherein the gas entrainment prevention device comprises a funnel-shaped member configured to be suspended from a suction port of the pump and collect the bubbles.

6. The liquid transfer apparatus according to claim 5, wherein the funnel-shaped member has a diameter larger than a diameter of the suction port.

7. The liquid transfer apparatus according to claim 5, wherein the gas entrainment prevention device comprises a gas discharge pipe connected to the funnel-shaped member.

8. The liquid transfer apparatus according to claim 5, wherein the gas entrainment prevention device comprises a guide member disposed in a horizontal pipe, and
wherein the guide member is configured to generate a swirling flow of the liquefied gas by constricting a flow of the liquefied gas flowing through the horizontal pipe.

9. A liquid transfer apparatus comprising:
a pump configured to suck a liquefied gas from below the pump and transfer the liquefied gas upward the pump;
a horizontal pipe configured to supply the liquefied gas to a position in a vertical pipe below the pump; and
a gas entrainment prevention device configured to be supported by the pump and not to be connected to the vertical pipe.
